(19) United States
(12) Patent Application Publication
(10) Pub. No.: US 2019/0223989 A1
(43) Pub. Date: Jul. 25, 2019

(54) SURGICAL HAND DRILL

(71) Applicant: Young Jae KIM, Seoul (KR)

(72) Inventor: Young Jae KIM, Seoul (KR)

(21) Appl. No.: 16/071,084

(22) PCT Filed: Jan. 18, 2017
(86) PCT No.: PCT/KR2017/000623

§ 371 Date: Jul. 19, 2018

(30) Foreign Application Priority Data
Jan. 20, 2016 (KR) 10-2016-0007062

(51) Int. Cl. A61C 8/00; A61C 1/04; A61C 1/08

(52) U.S. Cl. CPC A61C 8/0089; A61C 1/08; A61C 1/04

(57) ABSTRACT

Disclosed is a surgical hand drill which drills a hole into which a fixture is inserted during an implant procedure, wherein at the end of the hand drill is a circular hollow plate attached thereto and at the other end is a handle. The circular hollow plate has a concave part and a convex part, and a circular drill bit is inserted into the hollow plate, the circular drill bit having a flat surface corresponding to the concave and convex parts of the hollow plate so that the convex part of the hollow plate having the concave and convex parts is inserted into the flat surface of the circular drill bit, thereby preventing the circular drill bit from separating from the hand drill even when rotated in forward or reverse directions.

### TECHNICAL FIELD

The present invention relates to a surgical hand drill and more specifically, to a surgical hand drill which adds a fixing device such that a drill bit used for an electric motor-driven drill may be connected to a manual handle and which has an improved drill bit.

### RELATED ART

In the field of dentistry, research into technologies has been underway for developing dental materials capable of replacing missing or damaged teeth so as to help restore the functions of teeth. Accordingly, researchers have actively carried out clinical trials in relation to this. Among other things, crown and bridge procedures where the adjacent teeth are prepared are widely performed to address tooth loss.

In another way, some of the natural teeth are replaced with artificial teeth (partial dentures) or all the natural teeth are replaced with artificial teeth (complete dentures) to address tooth loss. In this dental procedure, the adjacent teeth and the alveolar bone (the portion of the jaw bone) play an important role.

However, in the crown and bridge procedure, the adjacent healthy teeth need to be extracted. In addition, if many teeth are lost, a crown and a bridge are not enough to restore the function of the missing teeth and cannot withstand excessive occlusal pressure.

Actually, users feel inconvenient when they used and store partial and complete dentures.

Recently, much technical progress has been made in the field of dentistry. With the advanced technologies, titanium-based dentures (i.e. titanium-based implants) have been developed, which have no harmful effect to the human body and cause no resistance reaction of the human body even when being inserted into the jaw bone for a long time.

In the process of inserting such a dental implant, a hole with a proper diameter is made in the jaw bone into which an artificial tooth is inserted by means of a drill or a reamer (sort of a drill).

Then, when a fixture is rotated by means of a screw driver in the state where the fixture (i.e. artificial dental root) is inserted into the hole made in the jaw bone, the screw part of the fixture forms a screw inside the hole of the bone so as to be coupled to the screw.

An implant (artificial tooth) is screwed and inserted into the upper end of the fixture fixed and coupled to the jaw bone.

A drill bit used to drill a hole is mounted on the electric motor-driven body where a shaft is rotated by a motor and is rotated so as to drill a hole.

For more precise work, more and more medical practitioners manually rotate a drill to make a hole these days. Accordingly, there is a need to mount a conventional electric motor-driven drill onto a hand drill.

As a related art, a hand drill mounted onto an electric motor-driven body is presented, which was devised by this applicant and has been registered.

FIG. 1 is a perspective view illustrating the entire hand drill according to the registered patent of this application as a prior art document.

FIG. 2 is a sectional view illustrating a cross section of the hand drill in FIG. 1 and illustrating how a drill bit is coupled to the hand drill 10.

FIG. 3 illustrates a hand drill having a rotation protrusion 17 at the end of the hand drill, and a drill bit having a spiral-shaped groove 16 formed at the center of the drill bit. The rotation protrusion and the spiral-shaped groove are coupled to each other such that the drill bit used for an electric motor-driven drill may be used for a hand drill.

However, if a drill bit that is rotated by a motor is used for a hand drill, the drill bit might escape from the body while rotating in the reverse direction.

Further, such a device is not appropriate for treating the gums of the teeth with accuracy because there is a gap between the hand drill and the drill bit which screw each other.

Accordingly, there is a need for a device in which there is no gap, and the drill bit does not escape from the hand drill when the drill bit escapes from the gums, rotating in the reverse direction.

### DETAILED DESCRIPTION OF THE INVENTION

### Technical Problems

According to the present invention as a means to solve the above-described problems, concave and convex grooves are formed at a cylinder-shaped sleeve wrapping a connection member for connecting a drill bit to the body.

Further, the present invention is directed to providing a surgical hand drill with high precision, in which the surface of the circular body of the drill bit is configured to have a flat surface such that the flat surface is forcibly fitted and inserted.

### Technical Solutions

The present invention devised as a means to solve the above-described problems constitutes a hand drill for drilling a hole into which a fixture is inserted during dental implant procedures.

A circular hollow plate is attached to the end of the hand drill.

A handle is provided at the other end of the hand drill.

The circular hollow plate has concave parts and convex parts.

A circular drill bit inserted into the hollow plate has a flat surface to correspond to the concave and convex parts of the hollow plate.

The convex parts of the hollow plate having the concave and convex parts are configured to be inserted into flat surfaces of the circular drill bit.

The present invention is directed to providing a surgical hand drill in which a gap is not created, and the circular drill bit does not escape form the hand drill even when the hand drill rotates in forward and reverse directions.

Preferably, the hollow plate having the concave and convex parts consists of two concave parts and two convex parts. Further, the circular drill bit has two flat surfaces such that the drill bit does not escape.

### Advantageous Effects

According to the present invention, precise and accurate work may be performed while the hand drill body and the drill bit do not escape from the body, and also, a drill bit used for an electric motor-driven drill may be coupled to a hand drill such that the medical practitioner manually rotates the drill bit.

### BRIEF DESCRIPTION OF THE DRAWINGS

FIG. 1 is an exploded view illustrating a state where parts of a hand drill are coupled according to a conventional invention.

FIG. 2 is a sectional view illustrating the inner structure of the hand drill according to FIG. 1.

FIG. 3 is a perspective view illustrating the process of inserting a drill bit into the sleeve according to FIG. 1.

FIG. 4 is a perspective view of a hand drill of the present invention.

FIG. 5 is a block diagram of a sleeve of the present invention.

FIG. 6 is a block diagram of a sleeve to which the end of a drill bit of the present invention is coupled.

FIG. 7 is a block diagram of a drill bit of the present invention.

FIG. 8 where FIGS. 5 and 7 are coupled is a block diagram illustrating a state where a drill bit is coupled to a sleeve.

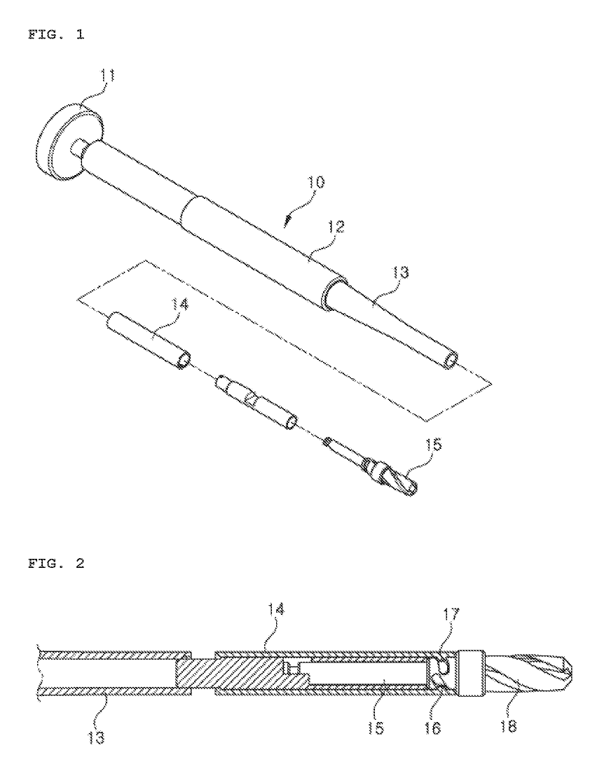

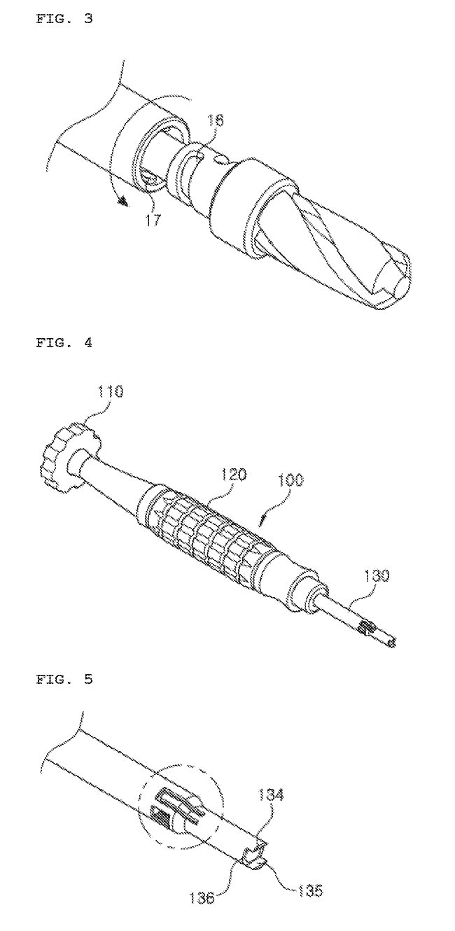

### BEST MODE FOR CARRYING OUT THE INVENTION

FIG. 8 will be described as a best embodiment of the present invention as follows.

A circular hollow plate has concave parts 136, 136′ and convex parts 134,134′.

The fourth mounting surfaces are configured to have flat surfaces corresponding to those of third mounting surfaces such that the fourth mounting surfaces 235, 235′ in FIG. 4 at the center of the circular drill bit 200 inserted into the circular hollow plate are forcibly inserted into the third mounting surfaces 135, 135′.

Two convex parts 134, 134′ of the hollow plate having the concave and convex parts are configured to be inserted into the fourth mounting surfaces 235, 235′—i.e. two flat surfaces of the circular drill bit.

With this configuration, the circular drill bit 200 does not escape from the hand drill 100 even when the hand drill rotates in forward and reverse directions.

### MODE FOR CARRYING OUT THE INVENTION

The present invention devised to solve the above-described problems will be described with reference to the attached drawings.

FIG. 4 is a perspective view of the present invention.

A surgical hand drill 100, which drills a hole into which a fixture is inserted during the implant procedure, has a hand drill body 120 to which a drill bit is fixed so as to be appropriate for work. After the drill bit is fixed, a rotation plate 110 is held, and the body is rotated such that the drill 200 makes a hole in order for an implant to be planted into the gums.

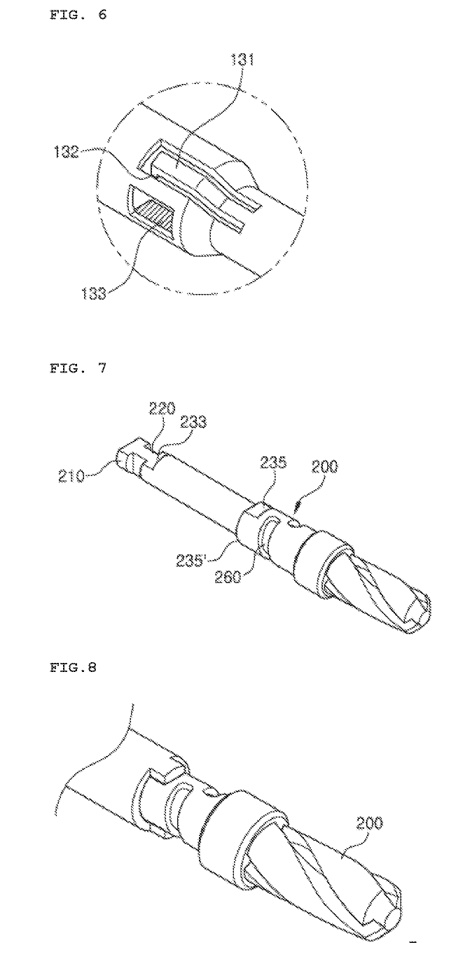

The present invention will be described with reference to FIGS. 5 and 6 as follows.

A hand drill sleeve 130 is configured to have a circular hollow plate and is configured to have a coupling protrusion spring 131 with a plate spring shape such that the end of the drill bit may be gripped thereby coupling the end of the drill bit 200 to the hand drill body 120, and an end of the spring has a first coupling protrusion 132.

On the basis of FIG. 7, the first coupling protrusion 132 of the hand drill is bound with a coupling groove 220 of the end of the drill bit.

Further, a first mounting flat surface is formed at an inner surface 133 of the sleeve of the hand drill to correspond to a second mounting surface 233, a flat surface of the end of the drill bit.

Even when being pulled, the first coupling protrusion 132 in FIG. 6 is coupled to the coupling groove 220 of the drill bit such that the drill bit does not escape from the sleeve of the hand drill body.

The direction in FIG. 7 is coupled to the first mounting flat surface 133 of the inner surface of the sleeve such that the second mounting surface 233 is coupled to the first mounting surface 133 of the inner surface of the sleeve when the drill bit is coupled to the sleeve of the hand drill body.

When the drill bit is spaced apart from the sleeve, fourth mounting flat surfaces 235, 235′ are allowed to escape from convex parts 134, 134′ of the sleeve and rotate a half such that the first coupling protrusion 132 is disposed at the second mounting flat surface 233. Then, the drill bit escapes from the sleeve.

The surface area of the coupling groove is wider than a distance of the fourth mounting flat surfaces in the length direction thereof such that the drill bit is easily inserted into the hand drill body or is allowed to easily escape from the hand drill body.

FIG. 8 is a view illustrating a state where FIGS. 5 and 7 are coupled.

FIGS. 5 and 7 to 8 will be described as follows.

The circular hollow plate has concave parts 136, 136′ and convex parts 134, 134′.

The fourth mounting surfaces are configured to have flat surfaces corresponding to those of third mounting surfaces such that the fourth mounting surfaces 235, 235′ in FIG. 4 at the center of the circular drill bit 200 inserted into the circular hollow plate are forcibly inserted into the third mounting surfaces 135, 135′.

The convex parts 134, 134′ of the hollow plate having the concave and convex parts are configured to be inserted into the fourth mounting flat surfaces 235, 235′—i.e. flat surfaces of the circular drill bit.

With this configuration, the circular drill bit 200 does not escape from the hand drill 100 even when the hand drill rotates in forward and reverse directions.

Preferably, the hollow plate having the concave and convex parts consists of two concave parts 136, 136′ and two convex parts 134, 134′.

The circular drill bit has two flat surfaces 235, 235′ corresponding to these such that the circular drill bit does not escape even when the drill bit rotates in forward and reverse directions.

Accordingly, the end of the hollow plate has two convex parts.

Tow surfaces 235, 235′ of the drill bit, which are inserted into the end of the hollow plate, are configured to be flat.

The inner surfaces 135, 135′ of the two convex parts formed at the end of the hollow plate are configured to be flat so as to correspond to the two flat surfaces of the drill bit.

In doing so, even when a hole is made on the gums and afterwards, the hand drill rotates in a reverse direction, the hand drill does not escape.

Additionally, a gap is not created thereby making it possible to perform a precise dental implant procedure.

### INDUSTRIAL APPLICABILITY

The present invention allows the user to connect a drill bit that has been used for an electric motor-driven drill to a hand drill such that the user may use the drill bit by manually rotating the frill bit.

The present invention is directed to providing a surgical hand drill in which a gap is not created, and the drill bit does not escape form the hand drill even when the drill bit rotates in the reverse direction to escape from the gums.

According to the present invention, concave and convex grooves are formed at a cylinder-shaped sleeve wrapping a connection member for connecting the drill bit to the body.

The present invention is industrially applicable by providing a surgical hand drill with high precision in which the surface of the end of the drill bit with a circular body is configured to have a flat surface such that the flat surface is forcibly fitted and inserted.

What is claimed is:

1. A surgical hand drill comprising:
a hand drill which drills a hole into which a fixture is inserted during a dental implant procedure, wherein a circular hollow plate is attached to a sleeve of the hand drill, a handle is provided at the other end of the hand drill, and concave and convex parts are provided at the end of the circular hollow plate;
a circular drill bit which is inserted into the hollow plate;
a coupling groove which is provided at the end of the drill bit; and
a coupling protrusion spring with a plate-spring shape is provided at the sleeve of the hand drill such that the end of the drill bit may be gripped,
wherein a coupling protrusion is provided at an end having the coupling protrusion spring,
the coupling groove provided at the end of the drill bit is bound with the coupling protrusion,
the drill bit is configured to have a flat surface to correspond to the concave and convex parts of the hollow plate such that the convex parts of the hollow plate having the concave and convex parts are inserted into the flat surface of the circular drill bit, thereby preventing the circular drill bit from escaping from the hand drill even when the circular drill bit is rotated in forward or reverse directions.

2. The surgical hand drill according to claim 1, wherein the hollow plate having the concave and convex parts comprises two concave parts and two convex parts, and an inner surface of the hollow plate comprised of the two convex parts, and two surfaces of the circular drill bit are respectively configured to be flat.
